(19) United States
(12) Patent Application Publication
(10) Pub. No.: US 2018/0261124 A1
(43) Pub. Date: Sep. 13, 2018

(54) AN EDUCATION METHOD

(71) Applicant: Bayram UNAL, Istanbul (TR)

(72) Inventor: Bayram UNAL, Istanbul (TR)

(21) Appl. No.: 15/573,839

(22) PCT Filed: Jun. 16, 2016
(86) PCT No.: PCT/TR2016/050182

§ 371 Date: Nov. 14, 2017

(30) Foreign Application Priority Data
Jun. 18, 2015 (TR) 2015/07479
May 30, 2016 (TR) 2016/07170

(51) Int. Cl. G09B 19/00

(52) U.S. Cl. CPC G09B 19/00

(57) ABSTRACT

The application is related to an education method which enables to teach any kind of subject in 4 basic steps following some basic preparations carried out before the training.

### CROSS REFERENCE TO RELATED APPLICATIONS

This application is the national phase entry of International Application No. PCT/TR2016/050182, filed on Jun. 16, 2016, which is based upon and claims priority to Turkish Patent Application No. 2015/07479 tiled on Jun. 18, 2015 and Turkish Patent Application No. 2016/07170 filed on May 30, 2016, the entire contents of which are incorporated herein by reference.

### TECHNICAL FIELD OF THE INVENTION

The invention subject to the application is related to an education method which enables to teach any kind of subject in 4 basic steps following some basic preparations carried out before the training.

### BACKGROUND OF THE INVENTION

The present education methods are directed to teaching a subject to a person by providing only general information about a subject. The person who is being taught (student) is passive in such cases and the subjects that are taught are not long lasting. Moreover as such an education is boring the focus of the student is distracted. Just providing general information regarding a subject to a student is superficial education and it does not matter how successful the manner of expression or teaching is, it is unproductive for the recipient. In such an education learning is achieved at a maximum of 50%. What needs to be done here, is that the teacher needs to include the students into the subject while providing information regarding the subject to be taught and then has to check if the subject has been understood or not. Nowadays, student tracking and assessment and evaluation systems are present. However these systems are mostly computer aided and one on one attention, application and follow-up is not provided in such systems. The teacher needs to be sure that the student has understood the details and the essence of the issue and needs to personally keep tabs with the student.

In said invention the teacher shall first of all describe the subject generally to the student and then teach the subject in detail, following this, the teacher shall check if the student has understood the information supplied by using different methods and exercises.

Moreover the teacher shall give tasks to the student regarding the subject and shall ensure that the student participates to the lesson, therefore encouraging the student to learn and research. It is then possible for 100% learning to be achieved.

### SUMMARY OF THE INVENTION

The subject of this invention is to provide an education system which enables productive education. This method is formed of 4 basic steps, and it starts from the step of the teacher preparing the person to be taught and continues until the stage where the teacher assesses if the essence of the subject has been understood or not. By means of the present invention a more productive education can be given. Preparing the student to learn a subject and diverting the attention of the student to the subject to be taught, enables healthier education. Describing the essence of the subject first of all, then giving details about the subject and following this asking the student to carry out research and perform a presentation about the subject, shall ensure that the education given is long lasting.

### DETAILED DESCRIPTION OF THE INVENTION

The present invention is an education method. Although this education method comprises 4 basic steps, it aims to ensure that the recipient understands the subject clearly and that all the details of the subject are comprehended. Various preparations need to be made before providing the education method subject to the invention. It is crucial for the productivity of the education to carry out all preparations completely at this stage which is named “Pre-education preparation” or “Preliminary Preparation”.

### Preliminary Preparation (Pre Education Preparation):

These preparations comprise the following steps to be carried out thoroughly;
Providing a three step education document illustrated in Table 1
Preparing the tools or materials to be used,
Taking occupational safety precautions,
Arranging the study area.

TABLE 1
Education Kit

| | Basic Steps | Key Point | Reasons |
|---|---|---|---|
| No | (Step 1) | (Step 2) | (Step 3) |
| 1 | | | |

Once the preparations are completed, the 4 basic steps mentioned below shall be applied respectively.

### 1^{st} Step: Preparing the Student

At this step, the aim is to attract the attention of a student to the subject b increasing the student's perception and to ensure that the subject to be taught is intriguing. This step comprises the following;
Allowing the students to relax,
Drawing the attention of students to the subject,
Explaining the teaching operation to the students,
Understanding what the students know about the subject beforehand,
To present all of the tools, parts and documents to be used during the education process,
Ensuring that the students are brought to the correct position for learning.

In order for an education to be productive, this step needs to be carried out carefully.

### 2^{nd} Step: Presenting the Education Process to the Student

At this step, the subject to be taught shall be outlined to the student first of all in general and then shall be described in detail and shall be implemented (describing in accordance with the 3 step education document). This step comprises the following:
Before beginning to teach the lesson informing the student that the student shall be repeating, what he/she has learned,
To describe, show and implement each basic step once,
To describe, who and implement each basic step this time with key points,
To describe, show and implement each basic step, key points and the reasons thereof
Not to teach a student more than he/she can learn in one go.

At this step the student is informed that he/she shall be repeating the lesson and therefore it is ensured that the student is focused. The subject to be taught shall be outlined in general first of all, and then the key points are defined and following this the key points are explained together with the reasons thereof and therefore the subject is described three times which enables the education given to be long lasting. At this step the learning percentage of the student is around 50%. However the point that needs to be taken into account is that, the teacher should not give information that will exceed the learning capacity of the student in one go.

### 3^{rd} Step: Assessing the Performance of the Student

This step is the step to assess how much the student has understood what has been taught and to increase the learning percentage of the student up to 90%. The process comprises the following steps:
To ask the student to implement the subject (process) once and to correct the student if he/she has made a mistake,
To ask the student to perform the task once again and to ask them to describe the subject along with its basic steps,
To ask the student to perform the task once again and ask them to describe the basic steps together with the key points,
To ask the student to perform the task once again and to describe the basic steps together with the key points and the reasons thereof,
To ask the student to repeat the process until the teacher is sure that the student has completely understood the subject.

This step is related to the implementation of the subject that has been taught. in this step an opportunity is provided to the student to assess how much he/she has comprehended and the student is asked to repeat the subject and therefore it is ensured that the subject is better understood and learned. The student is asked to implement the task subject to the education and the mistakes are corrected in order to increase the productivity of the education.

### 4^{th} Step: Monitoring the Student

This step is necessary to ensure that the education given is long lasting, to given an opportunity to the student to ensure that the subjects learned by the student is reinforced, to encourage that the student is focused on the subject and to increase the learning level up to 100%. As the student that is followed up and given the task to implement the subject, knows that he/she needs to perform the task within a given period of time, and as the student is supported under the supervision of an expert/mentor to whom he/she can ask questions to, the student will not delay his/her studies, and therefore can implement more tasks and will be able to comprehend and will not forget what he/she as learned. This step comprises the following processes;
Giving a special task to the student,
Providing information on who the student can obtain information from while performing this task and to assign a mentor/expert who will help the student during said exercises.
To inform the student of the control intervals in which the students shall be checked
To encourage the student to ask questions,
To reduce coaching and monitoring

In conclusion according to the present invention; an effective and long lasting education is aimed to be provided by applying the above mentioned 4 basic steps and a thorough preparation carried out prior to the education to be given.

1. An education method, comprising the following four steps:
preparing a student,
presenting an education process to the student,
checking a performance of the student, and
monitoring the student.

2. The education method according to claim 1, wherein the step of preparing the student comprises the following sub steps,
allowing the student to relax,
drawing attention of student to a subject,
explaining a teaching process to the student,
understanding what the student knows about the subject beforehand,
presenting all of tools, parts and documents to be used during a education process, and
ensuring that the student is brought to the a correct position for learning.

3. The education method according to claim 1, wherein the step of presenting the education process to the student comprises the following sub steps,
informing the student that he/she shall be repeating what he/she has learnt before starting to teach a lesson,
describing, showing and implementing each step once,
describing, showing, and implementing each step this time with key points,
describing, showing, and implementing each step, the key points and reasons thereof,
wherein the student is not taught more than he/she can learn in one go.

4. The education method according to claim 1, wherein the step of checking the performance of the student comprises the following sub steps,
asking the student to implement the subject once and to correct the student if he/she has made a mistake,
asking the student to perform a task once again and to ask he/she to describe the subject along with its basic steps,
asking the student to perform the task once again and ask he/she to describe basic steps together with the key points,
asking the student to perform the task once again and to describe the basic steps together with the key points and the reasons thereof,
asking the student to repeat the process until the teacher is sure that the student has completely understood the subject.

5. The education method according to claim 1, wherein a step of following up the student comprises the following sub steps,
giving a special task to the student,
providing information on who the student can obtain information from while performing this task and to assign a mentor/expert who will help the student during the task,
informing the student of control intervals in which the student shall be checked,
encouraging the student to ask questions,
reducing coaching and monitoring.

6. The education method according to claim 1, wherein the method comprises the following sub steps of pre-education preparations,
providing education documents,
preparing the tools and materials to be used,
taking occupational safety precautions,
arranging a study area.

7. An education kit used in the education method according to claim 1, wherein the education kit comprises a written material which the steps of the education to be given is described, a written material in which the key points regarding the education given is described and a written material in which the reasons of the key points thereof is described.
